(19) United States
(12) Patent Application Publication
(10) Pub. No.: US 2008/0248212 A1
(43) Pub. Date: Oct. 9, 2008

(54) METHODS OF MAKING FUNCTIONALIZED FLUOROPOLYMER FILMS

(75) Inventors: Mark W. Muggli, Emmerting (DE); Douglas E. Weiss, Golden Valley, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/696,787

(22) Filed: Apr. 5, 2007

(51) Int. Cl. C08F 2/54

(52) U.S. Cl. 427/496

(57) ABSTRACT

Functionalized fluoropolymer films, methods of making functionalized fluoropolymer films, laminates comprising functionalized fluoropolymer films, and methods of using functionalized fluoropolymer films are described.

### SUMMARY

The present disclosure relates to methods of making functionalized fluoropolymer films.

The present description is directed to fluoropolymer films and laminates, and methods for preparing fluoropolymer films and laminates. The methods may increase the functionality and/or reactivity of a fluoropolymer film.

In one exemplary method of preparing a fluoropolymer laminate, the method comprises providing a substantially solid, partially fluorinated fluoropolymer film; coating a first surface of the fluoropolymer film with a first solution comprising one or more polymerizable monomers, optionally in a solvent, wherein the one or more polymerizable monomers comprise at least one polymerizable monomer having (i) a free-radically polymerizable group and (ii) at least one additional functional group thereon, the additional functional group selected from an ethylenically unsaturated group, an epoxy group, an azlactone group, an isocyanate group, an ionic group, and a silane group; forming a multilayer structure comprising the coated fluoropolymer film and a removable cover layer, wherein the first solution is disposed between the cover layer and the fluoropolymer film and further wherein the cover layer provides temporary protection from exposure to oxygen; exposing the multilayer structure to a controlled amount of electron beam radiation so as to graft the one or more polymerizable monomers to the first surface of the fluoropolymer film to provide a functionalized fluoropolymer film; removing the cover layer from the multilayer structure; and laminating to the functionalized fluoropolymer film a second polymer layer wherein the second polymer layer comprises at least one complementary functional group that associates with the functionalized fluoropolymer film. In this context, “associate” means to interact so as to increase intermolecular attraction. Such interaction may take the form of, for instance, forming a covalent bond between the fluoropolymer film and the second polymer layer, forming an ionic bond, or experiencing some other type of intermolecular attraction such as dipole-dipole or van der Waals.

In another aspect, the present invention is directed to a method of preparing a functionalized fluoropolymer film comprising providing a substantially solid partially fluorinated fluoropolymer film; coating a first surface of the fluoropolymer film with a solution comprising one or more polymerizable monomers, which monomers are optionally in a solvent, wherein the one or more polymerizable monomers comprises at least one polymerizable monomer having (i) a free-radically polymerizable group and (ii) an ethylenically unsaturated group, an epoxy group, an azlactone group, an isocyanate group, an ionic group, and a silane group; and exposing the fluoropolymer film to a controlled amount of electron beam radiation so as to graft the one or more polymerizable monomers to the fluoropolymer film, wherein the method results in a grafted fluoropolymer film having ethylenically unsaturated groups, epoxy groups, azlactone groups, isocyanate groups, ionic groups, or silane groups extending from the first surface.

These and other features and advantages of the present invention will become apparent after a review of the following detailed description of the disclosed embodiments and the appended claims.

### BRIEF DESCRIPTION OF THE DRAWINGS

The present invention is further described with reference to the appended figures, wherein:

FIG. 1 depicts exemplary method steps for making functionalized films of the present invention; and

FIG. 2 depicts exemplary method steps for making functionalized films of the present invention.

### DETAILED DESCRIPTION

Although the present description is provided in terms of specific embodiments, it will be readily apparent to those skilled in this art that various modifications, rearrangements, and substitutions can be made.

### Functionalized Substrates

In some embodiments, the functionalized films of the present invention have enhanced functionality and/or reactivity as a result of one or more surface modifications. The functionalized films comprise a number of components including, but not limited to, a substantially solid, partially fluorinated fluoropolymer film and grafted species extending therefrom.

The functionalized films comprise a substantially solid, partially fluorinated fluoropolymer film. By substantially solid is meant that the film has no voids or pores, such that the film is capable of forming a barrier layer. The substantially solid film is to be distinguished from a microporous membrane, nonwoven web, and porous fiber, none of which are substantially solid.

In one exemplary embodiment, the fluoropolymer film is a fluoroplastic, particularly a thermoplastic. The fluoropolymer film may, in particular embodiments, be derived from one or more fluorinated monomer. Particular fluorinated monomers include, for instance, tetrafluoroethylene, hexafluoropropylene, vinylidene fluoride, perfluoro(alkyl vinyl) ethers, perfluoro(alkoxy vinyl) ethers, chlorotrifluoroethylene, and combinations thereof. In some embodiments, the fluoropolymer film may further comprise, in addition to a fluorinated monomer, a non-fluorinated monomer such as an alpha-olefinic monomer (e.g., ethylene, propylene). Particular copolymers include copolymers of tetrafluoroethylene and ethylene (ETFE); copolymers of tetrafluoroethylene, hexafluoropropylene, and ethylene (HTE); and copolymers of tetrafluoroethylene, hexafluoropropylene, and vinylidene fluoride (THV).

One or more monomeric materials may be grafted onto the fluoropolymer film. Suitable monomeric materials include those having (i) a free-radically polymerizable group and (ii) at least one additional function group thereon. The free-radically polymerizable group is typically an ethylenically unsaturated group such as a (meth)acryloly group or a vinyl group. This group may react with the fluoropolymer film when exposed to electron beam radiation. That is, the free-radically polymerizable group may react with the substrate when exposed to electron beam radiation to graft the monomer to the substrate. In most embodiments, the additional functional group is selected from a second ethylenically unsaturated group, an epoxy group, an azlactone group, an isocyanate group, an ionic group, and a silane group. The additional functional group can provide a site that associates with a complementary functional group. In some instances, such association includes the formation of a covalent bond, an ionic bond, and/or intermolecular interactions such as dipole-dipole or van der Waals. For example, the additional functional group may react to form a linkage group between the fluoropolymer film and another material such as a second polymer layer that comprises at least one complementary functional group. The complementary functional group may, for instance, react with the functionalized fluoropolymer film to form a covalent bond between the fluoropolymer film and the second polymer layer.

Some polymerizable monomers have (i) a free-radically polymerizable group that is a first ethylenically unsaturated group and (ii) an additional functional group that is a second ethylenically unsaturated group. Suitable monomers having two ethylenically unsaturated groups include, but are not limited to, polyalkylene glycol di(meth)acrylates such as polyethylene glycol di(meth)acrylate monomers (e.g., polyethylene glycol diacrylate monomer having an average molecular weight of about 400 g/mole commercially available under the trade designation “SR344” and polyethylene glycol dimethacrylate monomer having an average molecular weight of about 400 g/mole commercially available under the trade designation “SR603”, both are available from Sartomer Co., Exton, Pa.) and poly(propylene glycol di(meth)acrylates monomers (e.g., polypropylene glycol dimethacrylate). As used herein the term “(meth)acrylate” is used to encompass both acrylates and methacrylates.

In one exemplary embodiment, the grafted species results from the reaction of a dimethylacrylamide monomer (DMA) with the fluoropolymer film upon exposure to an electron beam. In another embodiments, the grafted species results from the reaction of an acrylic acid monomer with the fluoropolymer film.

In yet further embodiments, the grafting reaction is carried out in the presence of trimethoylpropane triacrylate (TMPTA).

Some polymerizable monomers have (i) a free-radically polymerizable group that is a first ethylenically unsaturated group and (ii) an additional functional group that is an epoxy group. Suitable monomers within this class include, but are not limited to, glycidyl (meth)acrylate. This class of monomers can provide a fluoropolymer film having at least one epoxy group. The epoxy group can associate with other groups such as reacting with another monomer or with a nucleophilic group to impart a desired surface property or desired interlayer adhesion. The reaction of the epoxy group with a nucleophilic group, for example, results in the opening of the epoxy ring and the formation a linkage group that functions to attach, for instance, a second polymer to the fluoropolymer via a covalent bond. The second polymer may contain at least one nucleophilic group. Suitable nucleophilic groups for reacting with epoxy groups include, but are not limited to, primary amino groups, secondary amino groups, or carboxy groups. The second polymer layer may contain additional nucleophilic groups that can further react with the functionalized fluoropolymer film. The linkage group formed by ring-opening of the epoxy group may be given as the formula —C(OH)HCH₂NH— when the epoxy is reacted with a primary amino group or —C(OH)HCH₂O(CO)— when the epoxy is reacted with a carboxy group.

In some embodiments, the epoxy groups can be reacted with a diamine such as a diamine having two primary amino groups. One of the amino groups can undergo a ring opening reaction with the epoxy group and results in the formation of a linkage —C(OH)HCH₂NHR—NH—, wherein R is selected from a covalent bond and a divalent linking group. The second amino group can add a nucleophilic group to the functionalized fluoropolymer film and thereby react with a second polymer layer that contains groups that are reactive with a nucleophilic group (e.g., a complementary functional group). In some examples, the diamine is a polyethylene glycol diamine and reaction with an epoxy group results in the attachment of a polyethylene glycol chain to the fluoropolymer film.

Other polymerizable monomers have (i) a free-radically polymerizable group that is an ethylenically unsaturated group and (ii) an additional functional group that is an azlactone group. Suitable monomers include, but are not limited to, vinyl azlactone such as 2-vinyl-4,4-dimethylazlactone. This class of monomers can provide a fluoropolymer film having at least one azlactone group. The azlactone group can associate with complementary functional groups on a second polymer, such as by reacting with a nucleophilic group. The reaction of the azlactone group with a nucleophilic group, for example, results in the opening of the azlactone ring and the formation a linkage group that functions to attach the second polymer to the fluoropolymer film. The second polymer may contain at least one nucleophilic group. Suitable nucleophilic groups for reacting with an azlactone group include, but are not limited to, primary amino groups, secondary amino groups or hydroxy groups. The second polymer can contain additional nucleophilic groups that can react with azlactone groups. The linkage group formed by ring-opening of the azlactone group may be of the formula —(CO)NHCR₂(CO)— where R is an alkyl such as methyl and (CO) denotes a carbonyl. In the event an azlactone is present, care should be taken to limit exposure to moisture, as the azlactone moiety may be unstable under such conditions.

Still other polymerizable monomers have (i) a free-radically polymerizable group that is an ethylenically unsaturated group and (ii) an additional functional group that is an isocyanate group. Suitable monomers include, but are not limited to 2-isocyanatoethyl methacrylate and 2-isocyanatoethyl acrylate. This class of monomers can provide a fluoropolymer film having at least one isocyanate group. The isocyanate group can associate with complementary functional groups, such as by reacting with a nucleophilic group to covalently bond the fluoropolymer film to a second polymer layer. The reaction of an isocyanate group with a nucleophilic group may result in the formation of a urea linkage if the nucleophilic group is a primary amino or secondary amino group or in the formation of a urethane linkage if the nucleophilic group is a hydroxy group. The second polymer layer can contain additional nucleophilic groups that can react with multiple isocyanate groups. The linkage group formed by reaction of a nucleophilic group with an isocyanate group may be of the formula —NH(CO)NH— when the nucleophilic group is a primary amino group or —NH(CO)O— when the nucleophilic group is a hydroxy.

Yet other monomers have (i) a free-radically polymerizable group that is an ethylenically unsaturated group and (ii) an additional functional group that is an ionic group. The ionic group can have a positive charge, a negative charge, or a combination thereof. With some suitable monomers the ionic group can be neutral or charged depending on the pH conditions.

Some exemplary ionic monomers include sulfonic acids such as vinylsulfonic acid and 4-styrenesulfonic acid; (meth)acrylamidophosphonic acids such as (meth)acrylamidoalkylphosphonic acids (e.g., 2-acrylamidoethylphosphonic acid and 3-methacrylamidopropylphosphonic acid); acrylic acid and methacrylic acid; and carboxyalkyl(meth)acrylates such as 2-carboxyethylacrylate, 2-carboxyethylmethacrylate, 3-carboxypropylacrylate, and 3-carboxypropylmethacrylate. Still other suitable acidic monomers include (meth)acryloylamino acids, such as those described in U.S. Pat. No. 4,157,418 (Heilmann). Exemplary (meth)acryloylamino acids include, but are not limited to, N-acryloylglycine, N-acryloylaspartic acid, N-acryloyl-β-alanine, and 2-acrylamidoglycolic acid. Salts of any of these acidic monomers can also be used.

Other polymerizable monomers have (i) a free-radically polymerizable group that is an ethylenically unsaturated group and (ii) an additional functional group that is a silane group. Suitable monomers include, but are not limited to vinyl or acryloxy silanes (such as, for instance, 3-acryloxypropyl trimethoxysilane). This class of monomers can provide a fluoropolymer film having at least one silane group. The silane group can associate with complementary functional groups such as by reacting with a nucleophilic group to covalently bond the fluoropolymer film to a second polymer layer. The silane group may first undergo hydrolysis to form a siloxane as an intermediate step before reaction with a complementary group. The reaction of a silane group (or intermediate) with a nucleophilic group may result in the formation of a silazane linkage if the nucleophilic group is a primary amino or secondary amino group or in the formation of a siloxane linkage if the nucleophilic group is a hydroxy group. The second polymer layer can contain additional nucleophilic groups that can react with multiple silane groups.

As described in further detail below, functionalized fluoropolymer films described herein may be prepared using one of the above-described monomers or a mixture of two or more of the above-described monomers. When two or more of the above-described monomers are used the monomers may be grafted onto the fluoropolymer film in a single step or in sequential steps.

As discussed above, one or more reactants (e.g., other than grafted monomers) may be covalently bonded to the additional functional groups on the grafted species extending from the fluoropolymer film. That is, the additional functional groups such as ethylenically unsaturated groups, epoxy groups, azlactone groups, isocyanate groups, ionic groups, or silane groups can react with other monomers or with a nucleophilic compound to further modify the grafted monomers. The monomers or nucleophilic compound, for example, can have further functional groups that may associate with a complementary functional group on a second polymer layer.

Suitable groups include, but are not limited to polyether groups, (meth)acryloly groups, ionic group, or nucleophilic groups (e.g., hydroxy, amino groups, carboxy groups), and the like.

The functionalized fluoropolymer films described herein may associate with a variety of second polymers having complementary functional groups. Exemplary second polymers include, for instance, ethylene vinyl acetate (EVA), maleated polyethylene, acid modified polyethylene, and embossing resins such as Resin 669 available from Bostik (Wauwatosa, Wis.).

The functionalized fluoropolymer films described herein may further be functionalized on a second surface. This second surface may be modified, for instance, by grafting monomers as described above with respect to the first surface of the fluoropolymer films. The functionalized fluoropolymer film having two functionalized groups may further associate with a third polymer having complementary functional groups. Such third polymers may be the same or different than the second polymers described above.

### Method of Making Functionalized Substrates

The above-described fluoropolymer films may be prepared using a combination of process steps. In one exemplary embodiment, a method of preparing a fluoropolymer laminate comprises providing a substantially solid partially fluorinated fluoropolymer film. The method further comprises coating a first surface of the fluoropolymer film with a first solution comprising one or more polymerizable monomers, wherein the one or more polymerizable monomers comprise at least one polymerizable monomer having (i) a free-radically polymerizable group and (ii) at least one additional functional group thereon, the additional functional group selected from an ethylenically unsaturated group, an epoxy group, an azlactone group, an isocyanate group, an ionic group, and a silane group. The method may further comprise forming a multilayer structure comprising a fluoropolymer film coated on a first surface with a first solution comprising one or more polymerizable monomers in an optional solvent and a removable cover layer, wherein the first solution is disposed between the cover layer and the fluoropolymer film, the cover layer providing protection from exposure to oxygen. In some embodiments, the multilayer structure may be exposed to a controlled amount of electron beam radiation (or other actinic radiation) so as to graft the one or more polymerizable monomers to the first surface of the fluoropolymer film to provide a functionalized fluoropolymer film. The method may further comprise laminating onto the functionalized fluoropolymer film a second polymer layer wherein the second layer comprises at least one complementary functional group that associates with the functionalized fluoropolymer film. In some embodiments, the association takes the form of a covalent bond between the fluoropolymer film and the second polymer layer.

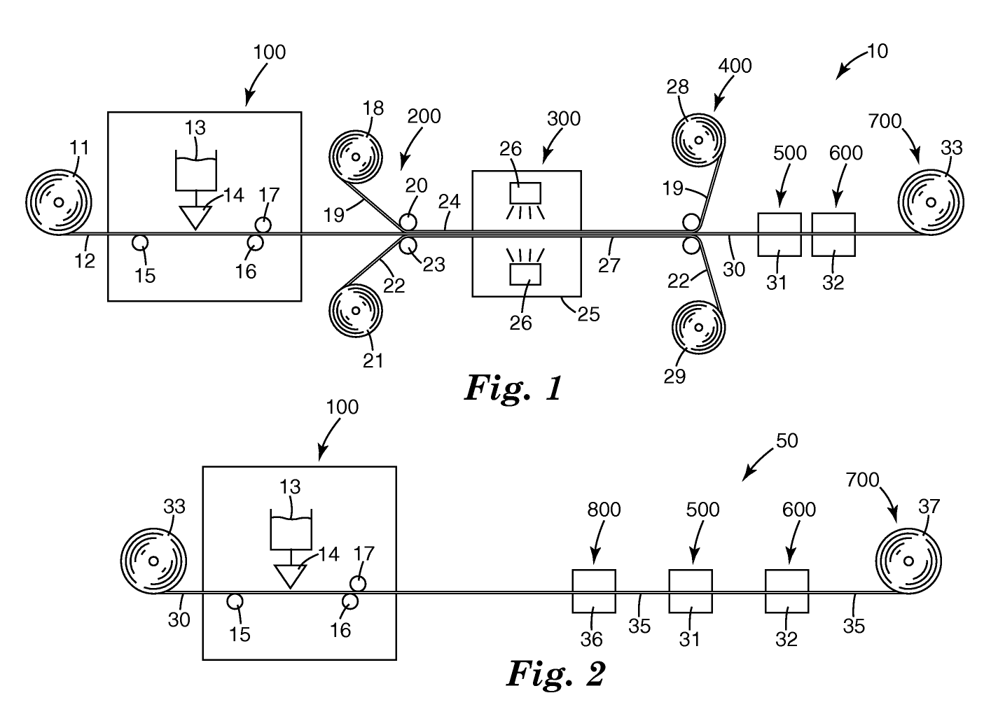

One exemplary method for making fluoropolymer films is depicted in FIG. 1. As shown in FIG. 1, exemplary method 10 comprises the following steps: coating step 100, covering step 200, irradiating step 300, peeling step 400, washing/rinsing step 500, drying step 600, and taking-up step 700.

As shown in FIG. 1, a roll 11 comprising fluoropolymer film 12 may be unwound so that fluoropolymer film 12 enters into coating step 100. In coating step 100, fluoropolymer film 12 is brought into contact or proximity to applicator 14 that is connected to a reservoir of solution 13 containing one or more monomeric materials. Rollers 15 and 16 guide fluoropolymer film 12 through solution 13 so that fluoropolymer film 12 is in contact with solution 13 for a desired amount of time. The dwell time of fluoropolymer film 12 in solution 13 is not particularly limited and may be, for instance, up to about 1.0 minutes, or even less than about 15 seconds. Fluoropolymer film 12 may proceed through coating step 100 and to irradiating step 300 in less than 1 minute. In some coating steps, fluoropolymer film 12 is saturated with solution 13.

Solution 13 may comprise one or more monomers suitable for grafting onto fluoropolymer film 12. The concentration of each monomer in solution 13 may vary depending on a number of factors including, but not limited to, the monomer or monomers in solution 13, the extent of grafting desired, the reactivity of the monomer(s), and the solvent used. The concentration of each monomer in solution 13 may range from about 1.0 wt % to about 100 wt % (that is, the solvent is optional), from about 5.0 wt % to about 30 wt %, and even from about 10.0 wt % to about 20 wt %, based on a total weight of solution 13.

Once fluoropolymer film 12 has been coated with solution 13 for a desired period of time, fluoropolymer film 12 may be directed toward covering step 200 via guide roller 17. Guide roller 17 may be used to meter excess solution 13 from fluoropolymer film 12 if so desired. Alternately, rollers (not shown) could be used to squeeze air bubbles and excess solution 13 from fluoropolymer film 12. Typically, fluoropolymer film 12 enters covering step 200 in a substantially saturated condition when all of at least one surface of fluoropolymer film 12 is coated with solution 13.

It should be noted that coating step 100 is only one possible method of introducing solution 13 onto fluoropolymer film 12. Other suitable methods include, but are not limited to, a spray coating method, flood coating method, and knife coating.

In covering step 200, coated fluoropolymer film 12 may be covered by optional removable carrier layer 22 and removable cover layer 19 to form multilayer structure 24. As shown in exemplary method 10, removable cover layer 19 may be unwound from roll 18 and brought into contact with an outer surface of coated fluoropolymer film 12 via roller 20. Covering step 200 may further comprise sandwiching the fluoropolymer film between removable cover layer 19 and removable carrier layer 22. The method may further comprise coating a second surface of the fluoropolymer film, which surface contacts optional carrier layer 22. Removable optional carrier layer 22 may be unwound from roll 21 and brought into contact with an outer surface of coated fluoropolymer film 12 via roller 23, which surface is opposite the first surface which contacts cover layer 19.

Removable cover layer 19 and optional removable carrier layer 22 may comprise any inert material that is capable of providing temporary protection to functionalized fluoropolymer film 30 (and coated fluoropolymer film 12) from direct exposure to oxygen. Removable cover layer 19 and optional removable carrier layer 22 may further provide for uniform wet-out of solution 13 onto fluoropolymer film 12. Suitable inert materials for forming removable cover layer 19 and optional removable carrier layer 22 include, but are not limited to, polyethylene terephthalate film material, other aromatic polymer film materials, and any other non-reactive polymer film material. Once assembled, multilayer structure 24 proceeds to irradiating step 300.

In irradiating step 300, multilayer structure 24 is exposed to a sufficient quantity of radiation so as to graft one or more monomers within solution 13 onto fluoropolymer film 12 so as to form multilayer structure 27 comprising functionalized fluoropolymer film 30 with removable cover layer 19 and optionally further comprising carrier layer 22. As shown in exemplary method 10, multilayer structure 24 proceeds through chamber 25, which contains at least one device 26 capable of providing a sufficient dose of radiation. A single device 26 is capable of providing a sufficient dose of radiation, although two or more devices 26 may be used especially for relatively thick fluoropolymer films 12. Typically, chamber 25 comprises an inert atmosphere such as nitrogen, carbon dioxide, helium, argon, or a mixture thereof, with a minimal amount of oxygen. Oxygen is known to inhibit free-radical polymerization. In embodiments wherein fluoropolymer film 12 is irradiated without removable cover layer 19, the amount of oxygen within chamber 25 is more of a concern. When removable cover layer 19 covers fluoropolymer film 12, exposure to oxygen within chamber 25 is minimal.

Although other sources of irradiation may be used, desirably device 26 comprises an electron beam source. Electron beams (e-beams) are generally produced by applying high voltage to tungsten wire filaments retained between a repeller plate and an extractor grid within a vacuum chamber maintained at about 10⁻⁶ Torr. The filaments are heated at high current to produce electrons. The electrons are guided and accelerated by the repeller plate and extractor grid towards a thin window of metal foil. The accelerated electrons, traveling at speeds in excess of 10⁷ meters/second (m/sec) and possessing about 150 to 300 kilo-electron volts (keV), pass out of the vacuum chamber through the foil window and penetrate into whatever material is positioned immediately below the window.

The quantity of electrons generated is directly related to the extractor grid voltage. As extractor grid voltage is increased, the quantity of electrons drawn from the tungsten wire filaments increases. E-beam processing can be extremely precise when under computer control, such that an exact dose and dose rate of electrons can be directed against multilayer structure 24.

Electron beam generators are commercially available from a variety of sources, including the ESI “ELECTROCURE” EB SYSTEM available from Energy Sciences, Inc. (Wilmington, Mass.), and the BROADBEAM EB PROCESSOR available from PCT Engineered Systems, LLC (Davenport, Iowa). For any given piece of equipment and irradiation sample location, the dosage delivered can be measured in accordance with ASTM E-1275 entitled “Practice for Use of a Radiochromic Film Dosimetry System.” By altering extractor grid voltage, beam diameter and/or distance to the source, various dose rates can be obtained.

The temperature within chamber 25 is desirably maintained at an ambient temperature by conventional means.

Without intending to be limited to any particular mechanism, it is believed that by conducting e-beam grafting, that free radical initiation takes place on the fluoropolymer film by loss of a hydrogen atom on the film, thus allowing reaction with double bond-functional monomers and free-radicals generated from the irradiated monomers.

The total dose received by multilayer structure 24 primarily affects the extent to which monomer is grafted to fluoropolymer film 12, the extent to which monomer is converted to polymer, and the extent to which the polymers are crosslinked. In general, it is possible to convert at least 10 wt %, 20 wt %, even greater than 50 wt % of the monomers in solution 13 to grafted polymer. Further, it is possible to graft as much as about 5 wt %, desirably as much as about 10 wt %, more desirably as much as about 20 wt % (or as much as about 100 wt %) of one or more monomers from solution 13 onto fluoropolymer film 12, based on a total weight of fluoropolymer film 12.

Electron beam dose is dependent upon a number of processing parameters, including voltage, speed and beam current. Dose can be conveniently regulated by controlling line speed (i.e., the speed with which multilayer structure 24 passes under device 26), and the current supplied to the extractor grid. A target dose (e.g., 20 kGy) can be conveniently calculated by multiplying an experimentally measured coefficient (a machine constant) by the beam current and dividing by the web speed to determine the exposure. The machine constant varies as a function of beam voltage.

While the controlled amount of electron beam radiation exposure is dependent upon the residence time, as a general matter, multilayer structure 24 may be significantly grafted upon receiving a controlled amount of dosage ranging from a minimum dosage of about 10 kGy (1 Mrad) to a maximum dosage of about 60 kGy (6 Mrad). The total controlled amount of dosage may range from about 20 kGy (2 Mrads) to about 40 kGy (4 Mrads). While low dose rates and longer residence times are preferred for radiation grafting, practical operation may lead an operator to choose speeds that force higher dose rates and shorter residence. Exclusion of oxygen in a multilayer article may also allow free radical chemistry to continue after E-beam exposure for a duration sufficient to improve the grafting yield.

Upon exiting chamber 25, multilayer structure 27 proceeds toward peeling step 400. In peeling step 400, multilayer structure 27 is disassembled by separating removable cover layer 19 and optional removable carrier layer 22 from functionalized fluoropolymer film 30. As shown in exemplary method 10, removable cover layer 19 is separated from an outer surface of functionalized fluoropolymer film 30 and taken-up as roll 28, while optional removable carrier layer 22 is separated from an opposite outer surface of functionalized fluoropolymer film 30 and taken-up as roll 29.

In one embodiment, after exposure to an electron beam and exiting chamber 25, removable cover layer 19 and optional removable carrier layer 22 are allowed to remain on functionalized fluoropolymer film 30 for a period of time prior to peeling step 400 so as to provide prolonged protection of functionalized fluoropolymer film 30 from exposure to oxygen. Removable cover layer 19 and optional removable carrier layer 22 may remain on functionalized fluoropolymer film 30 for a period of time of at least 15 seconds, or even from about 30 to about 60 seconds after exiting chamber 25. There does not seem to be an upper time limit that will reduce grafting quality. Thus, multilayer structure 27 can remain intact for an extended time period as would be the case if batch processing rolls of multilayer structure 27. Once multilayer structure 27 is disassembled, functionalized fluoropolymer film 30 proceeds to an optional washing/rinsing step 500.

In optional washing/rinsing step 500, functionalized fluoropolymer film 30 is washed or rinsed one or more times in rinse chamber 31 in order to remove any unreacted monomer material, solvent or other reaction by-products from functionalized fluoropolymer film 30. Typically, functionalized fluoropolymer film 30 is washed or rinsed up to three times using a water rinse, an alcohol rinse, a combination of water and alcohol rinses, and/or a solvent rinse (e.g., acetone, methyl-ethyl ketone (MEK)). When an alcohol rinse is used, the rinse may include one or more alcohols including, but not limited to, isopropanol, methanol, ethanol, or any other alcohol that is practical to use and an effective solvent for any residual monomer. In each rinse step, functionalized fluoropolymer film 30 may pass through a rinse bath or a rinse spray.

In optional drying step 600, functionalized fluoropolymer film 30 is dried to remove any rinse solution from functionalized fluoropolymer film 30. Functionalized fluoropolymer film 30 may be dried in oven 32 having a relatively low oven temperature for a desired period of time (referred to herein as “oven dwell time”). Oven temperatures may, for instance, range from about 60° C. to about 120° C., while oven dwell times may range from about 120 to about 600 seconds.

Any conventional oven may be used in optional drying step 600 of the present invention. Suitable ovens include, but are not limited to, a convection oven.

It should also be noted that in other embodiments drying step 600 can proceed before washing/rinsing step 500 so as to eliminate volatile components before extraction of non-grafted monomer residue.

Following optional drying step 600, dried functionalized fluoropolymer film 30 may be taken up in roll form as roll 33. Functionalized fluoropolymer film 30 may be stored for future use in roll form, used immediately as is, or further processed to further alter the surface properties of functionalized fluoropolymer film 30.

In one exemplary embodiment, functionalized fluoropolymer film 30 is further processed to alter the surface properties of functionalized fluoropolymer film 30. In this embodiment, functionalized fluoropolymer film 30 is processed through a graft polymerization process such as exemplary method 10 for a second time (or even more times) in order to (i) graft additional monomers onto functionalized fluoropolymer film 30, (ii) graft additional compounds (for instance, additional monomers) onto grafted species extending from functionalized fluoropolymer film 30, or (iii) both (i) and (ii).

In yet further embodiments, the present method may further comprise a lamination step (not shown in Figures). Lamination may include, for instance, vacuum lamination. In vacuum lamination, functionalized fluoropolymer film 30 may be set upon a second polymer layer (e.g., EVA) that is situated on a carrier substrate (e.g., glass). The multi-layer material may then be placed in a vacuum laminator, such as those available from Vacuum Laminating Technology Inc (Fort Bragg, Calif.). The vacuum laminator may be pre-heated, for instance, up to 145° C. in a heated hydraulic press. Once set in the vacuum laminator, the pressure may be reduced (e.g., to about 5 mbar) such that a bladder around the specimen is tightly sealed. The vacuum lamination may last for at least one minute, at least five minutes, or even 10 minutes or longer. No external forces besides that from the vacuum need be applied to the specimen, although additional pressure may be applied if desired. The specimen may then be allowed to cool.

In a further exemplary embodiment, functionalized fluoropolymer film 30 is further processed (i.e., after a single pass or numerous passes through a graft polymerization process such as exemplary method 10) to further alter the surface properties of functionalized fluoropolymer film 30 by passing functionalized fluoropolymer film 30 through a process such as shown in exemplary method 50 in FIG. 2. In this embodiment, functionalized fluoropolymer film 30 is brought into contact with a solution containing one or more reactants that reacts with functional groups along grafted species of functionalized fluoropolymer film 30.

As shown in FIG. 2, exemplary method 50 starts by removing functionalized fluoropolymer film 30 from roll 33, and guiding functionalized fluoropolymer film 30 into coating step 100. In coating step 100, functionalized fluoropolymer film 30 is brought into contact with solution 13 containing one or more reactants. The reactants may be polymerizable monomers, compounds that are reactive with one or more functional groups along grafted species of functionalized fluoropolymer film 30 (e.g., epoxy groups, ethylenically unsaturated groups, azlactone group, isocyanate groups, ionic groups, or silane groups), or a combination thereof. Rollers 15 and 16 guide functionalized fluoropolymer film 30 through solution 13 so that functionalized fluoropolymer film 30 is in contact with solution 13 for a desired amount of time. Typically, the dwell time of functionalized fluoropolymer film 30 in solution 13 is less than about 1.0 minute.

The concentration of each reactant in solution 13 may vary depending on a number of factors including, but not limited to, the reactant or reactants in solution 13, the extent of surface modification desired, and the solvent used. The concentration of each reactant in solution 13 may range from about 5.0 wt % to about 100 wt % based on a total weight of solution 13.

Once functionalized fluoropolymer film 30 has been coated with solution 13 for a desired period of time, functionalized substrate 30 is directed toward an optional heating step 800 via guide roller 17. Guide roller 17 may be used to meter excess solution 13 from functionalized fluoropolymer film 30 if so desired. Typically, functionalized fluoropolymer film 30 enters optional heating step 800 in a substantially saturated condition.

Although not shown in FIG. 2, exemplary method 50 could include an optional step wherein functionalized fluoropolymer film 30 coated with solution 13 is covered by removable materials, such as a removable carrier layer or a removable cover layer comprising a non-reactive polymer film, such as PET, in order to prevent evaporation of chemicals and/or solvent carrier during heating step 800, so as to prevent VOC emissions and to eliminate or at least attenuate potential flammability issues. In this embodiment, a peeling step similar to peeling step 400, may follow heating step 800.

In optional heating step 800, functionalized fluoropolymer film 30 is heated to facilitate the reaction between reactants within coating solution 13 and one or more functional group along grafted species of functionalized fluoropolymer film 30 so as to produce further functionalized substrate 35. Functionalized fluoropolymer film 30 may be heated in oven 36 having an oven temperature of up to about 120° C. depending on a number of factors including, but not limited to, the reactants, the fluoropolymer film, the functional groups present on the grafted species, and the dwell time within oven 36. The oven temperature used in optional heating step 800 may be 30° C. or greater (40° C. or greater, 50° C. or greater, 60° C. or greater). The oven temperature may range from about 60° C. to about 120° C. Oven dwell time in optional heating step 800 may range from about 60 seconds to about 1 hour.

Any conventional oven may be used in the optional heating step of the present invention, such as optional heating step 800 of exemplary method 50. Suitable ovens include, but are not limited to, the above-described ovens used in optional drying step 600 of exemplary method 10. For instance, the oven used in optional heating step 800 of exemplary method 50 may comprise a circulating air oven.

Once further functionalized fluoropolymer film 35 exits oven 36, further functionalized fluoropolymer film 35 may pass through an optional washing/rinsing step 500 and an optional drying step 600 as described above. Following optional drying step 600, dried further functionalized fluoropolymer film 35 may be taken up in roll form as roll 37. Further functionalized fluoropolymer film 35 may be stored for future use in roll form, used immediately as is, or further processed in one or more additional process steps (not shown). Suitable additional process steps may include, but are not limited to, a reaction step or a coating step wherein a coating composition is applied to further functionalized fluoropolymer film 35, a lamination step wherein one or more additional layers are temporarily or permanently joined to further functionalized fluoropolymer film 35, an assembling step wherein further functionalized fluoropolymer film 35 is combined with one or more additional components to form a finished product, a packaging step wherein further functionalized fluoropolymer film 35 or a finished product comprising further functionalized fluoropolymer film 35 is packaged within a desired packaging material (e.g., a polyethylene film or bag), or any combination thereof.

In some embodiments, the films described herein may be used as frontside panels in solar cells. Solar frontside films may have high light transmission, which can lead to higher efficiency of a solar cell energy collection unit. Frontside films and components may be stable to ultraviolet radiation, moisture, chemical exposure, temperature, or some combination thereof. The fluoropolymer films described herein, in some embodiments, have some or all of these properties. It may also be advantageous for any bonding solution used to facilitate bonding of the fluoropolymer film used as a frontside panel to have some or all of these properties. The e-beam grafted functionalized fluoropolymer films described herein fulfill these requirements. Without wishing to be bound by theory, it is thought that the thin functionalized coating, the cross-linked nature, the chemical makeup, or some combination thereof contributes to the beneficial properties of the functionalized fluoropolymer films described herein.

It should be noted that the methods of making functionalized fluoropolymer films described herein may be performed using a continuous process, such as exemplary method 10 shown in FIG. 1, or alternatively, using a batch process wherein one or more of the above-described process steps are performed separate from one another. Desirably, the methods of making functionalized substrates are performed using a continuous process, such as exemplary method 10 shown in FIG. 1.

When using a continuous process, such as exemplary method 10, one or more drive rolls (not shown) may be used to move fluoropolymer film 12 or functionalized fluoropolymer film 30 through the continuous process. The one or more drive rolls provide sufficient tension on fluoropolymer film 12 and/or functionalized fluoropolymer film 30 to move them through a given apparatus. Care should be taken when determining the amount of tension to apply in order to prevent shrinkage and/or tearing of fluoropolymer film 12 or functionalized fluoropolymer film 30 during processing. In the exemplary continuous graft polymerization process of the present invention, the one or more drive rolls typically operate in a range of 5 to 40 lbs (22 to 178 Newtons) of tension on a (12 inch) 30 cm wide web of fluoropolymer film 12 or functionalized fluoropolymer film 30 in order to move them through a given apparatus, resulting in a tension of 0.7 to 5.9 Newtons per lineal centimeter of fluoropolymer film 12 or functionalized fluoropolymer film 30. In one desired embodiment, the one or more drive rolls operate in a range of 1.4 to 3.0 Newtons per lineal centimeter of fluoropolymer film 12 or functionalized fluoropolymer film 30.

In the exemplary continuous graft polymerization process of the present invention, the one or more drive rolls also provide a desired line speed through a given apparatus. Fluoropolymer film 12 and functionalized fluoropolymer film 30 may move through a given apparatus at a line speed of at least about 1.52 meters/minute (mpm) (5 fpm). In some embodiments, the line speed ranges from about 3.05 mpm (10 fpm) to about 30.5 mpm (100 fpm).

In any of the above-described methods of making a functionalized fluoropolymer film, any of the above-mentioned fluoropolymer films, monomers, and reactants may be used to form a given functionalized fluoropolymer film. In one exemplary embodiment, the fluoropolymer film comprises a copolymer of tetrafluoroethylene and propylene and optionally further comprises hexafluoropropylene.

The disclosed methods of making functionalized fluoropolymer film may be used to prepare a variety of functionalized fluoropolymer films. In one exemplary embodiment, the disclosed methods may be used to graft one or more polymerizable monomer onto a fluoropolymer film, wherein the one or more polymerizable monomers comprise at least one polymerizable monomer having (i) a free-radically polymerizable group and (ii) at least one additional functional group thereon (e.g., an ethylenically unsaturated group, an epoxy group, an azlactone group, an isocyanate group, an ionic group, or a silane group).

The present invention is described above and further illustrated below by way of examples, which are not to be construed in any way as imposing limitations upon the scope of the invention.

### EXAMPLES

Unless otherwise noted, all solvents and reagents were or can be obtained from Sigma-Aldrich Corp., St. Louis, Mo. Also, unless stated otherwise, concentrations are given in weight percent.

### Electron Beam Processing

Electron beam irradiation was carried out using a Model CB-300 electron beam system, obtained from Energy Sciences, Inc., (Wilmington, Mass.). The film samples were covered with a sheet of poly(ethylene terephthalate) film (PET) for the irradiation.

The following procedure was used unless otherwises specified. Onto a sample of film was placed a larger area size piece of 3-mil thick PET. This multi-layer structure was then opened and the sample film was wetted with monomer solution. Trapped air bubbles were removed and excess liquid was squeezed out by gently applying a rubber roller over the surface. The multi-layer structure was conveyed through the electron beam processor at a speed of 20 fpm and at a voltage of 300 keV with sufficient beam current applied to the cathode to deliver the targeted dose. The beam was calibrated using thin film dosimeters, calibrated and traceable to a national standards laboratory (RISO, Denmark). In some cases, to lower the overall dose rate and increase residence time while under the beam, the dose was fractionated by multiple passes through the beam to simulate a longer exposure time more characteristic of electron beams with cathodes extended in the web direction.

After the sample passed through the beam, the film was allowed to sit for a minute or more before having the cover removed, the sample removed and allowed to soak in a tray of water. The water in the tray was changed three times. The sample was then blotted with paper towels and allowed to air dry. Residual monomers not easily removed with water were extracted by washing with MEK, alcohol or other suitable solvent as specified in the examples.

Peel strength test. A strip of the specimen to be tested, at least 1.0 cm wide and at least 2.5 cm in length, was prepared. A crack (1.0 cm minimum length) was initiated between the layers between which peel strength was to be measured. Each layer was placed in an opposed clamp of an Instron Tensile Tester (model 5564) obtained from Instron Corporation (Canton, Mass.). Peel strength was measured at a cross-head speed of 150 millimeters/minute as the average load for separation of to the two layers. Unless otherwise noted, reported peel strengths represent an average of at least three samples.

### Example 1

Preparation of grafted films from neat monomer. An amount of 1% TMPTA and 0.2 M urea (0.6 g/100 ml) was added to dimethylacrylamide (DMA) and to acrylic acid (AA) monomer to prepare neat monomer grafting solutions. An additional 5% of methanol was added to the DMA solution to dissolve the urea. Samples of FEP, THV and EVA/PET laminate were wetted with grafting solution and sandwiched between two sheets of PET to form a smooth and continuous layer of solution over the surface of the film to be grafted and these were then conveyed on a web through an ESI CB-300 Electrocurtain electron beam at a speed of 20 fpm and received a dose of 40 kGy (4 Mrads) at an accelerating voltage of 300 kV. The films were then removed from the sandwich and washed several times in water and air dried. The films were then rewetted with droplets of water to assess their hydrophilicity, an indication of grafting success. The AA appeared to have grafted well to FEP, the EVA/PET and especially to the THV (no beading of water at all on rewetted film). There was an excess of DMA homopolymer on the EVA side of the EVA/PET laminate but both sides rewetted well. The FEP rewet well and was very sticky on the surface when wet. The high solids content of the grafting solutions also lead to a significant amount of grafting to the PET cover sheets and this made removal in some cases difficult.

### Example 2

Preparation of grafted films from monomer solution, lamination and peel test. The DMA solution was diluted to 30% concentration in methanol and enough urea was added to make it 0.2 M. THV-800, HTE 1500, and ETFE films were grafted with this solution in the same manner as Example 1. There was no obvious homopolymer formation on the surfaces. The THV was still tightly bound to the PET cover sheet and was very hydrophilic when separated.

Lamination. The grafted films were bonded to an EVA material available as Photocap Solar Encapsulants (available from Specialized Technology Resources, Inc., Enfield, Conn.) (hereinafter STR-EVA) that was peroxide cured. The bond was achieved during a vacuum lamination cycle. First, a lay-up of glass/15295P/UF/grafted film was placed into a polyethylene Ziploc® bag equipped with a vacuum port at ambient temperature. Then a vacuum was applied for two minutes. Subsequently the bag was placed at 88° C. in a Wabash press and a nominal pressure of 25 psi was applied to the vacuum bag. The temperature was then set for 150° C. and after the temperature reached 143° C., a timer was set for 5 minutes. After 5 minutes, the sample was cooled with air/water quenching until the temperature was again below 88° C. Peel strengths were measured according to the method above.

TABLE 1
Peel strengths of grafted fluorocarbon polymers to STR-EVA.

| Multi-layer structure materials | Peel Strength |
|---|---|
| THV-800-g-dma/EVA-peroxide cured | 12.6 +/− 0.5 N/cm |
| HTE1500-g-dma/EVA-peroxide cured | 12.7 +/− 2.2 N/cm |
| ETFE-g-dma/EVA-peroxide cured | 11.2 +/− 2.0 N/cm |

Without DMA-grafting, there was no bond at all between these films when laminated by this procedure.

### Example 3

Preparation of grafted films from monomer solution and heat-seal peel test. A series of DMA and AA-grafted THV and Ateva AT 1240A (EVA12) films (12% vinyl acetate) were prepared by the method of Example 1 using 30% concentrations of monomer. These grafted films were then heat sealed using a hot bar machine (available from Sencorp Systems, Hyannis, Mass.) and tested for peel strength, using the above procedure. The DMA-grafted THV appears to form a very strong bond to AA-grafted EVA. Peel values in the range of 5-7 N/cm are ordinarily considered to be good. The grafted EVA films can be adhered directly to glass.

TABLE 2
Peel strength (N/cm) of heat-sealed laminates.

| | | | | | Primacore- | | | | | |
|---|---|---|---|---|---|---|---|---|---|---|
| | MA-PE^{a} | | EVA12 | | 3440 | | EVA12-DMA | | EVA12-AA | |
| Grafted polymers | a) | b) | a) | b) | a) | b) | a) | b) | a) | b) |
| THV- | 7.7 | 5.1 | 0.04 | 0 | 5.0 | 4.3 | ^{b} | ^{b} | 5.3 | 5.9 |
| DMA | 7.3 | 4.8 | 0.02 | 0 | 5.1 | 4.1 | ^{b} | ^{b} | 3.4 | 5.5 |
| | tears | tears | | | | | | | tears | tears |
| THV- | 6.8 | 6.9 | ^{b} | 0 | 0.9 | 2.9 | 2.5 | 3.2 | 3.7 | ^{b} |
| AA | 3.1 | 6.2 | ^{b} | 0 | 0.9 | 1.9 | 1.4 | 2.6 | 6.3 | ^{b} |
| | tears | tears | | | | | tears | tears | tears | |
| THV | 0 | 0 | 0 | 0 | 0.4 | ^{b} | 0.2 | 0 | ^{b} | ^{b} |
| | 0 | 0 | 0 | 0 | 0.5 | ^{b} | 0.4 | 0 | ^{b} | ^{b} |

a) 204° C., 10 sec, 413 kPa
b) 177° C., 10 sec, 413 kPa
^{a}maleated polyethylene
^{b}not measured

### Example 4

Preparation of grafted films and lamination to Bostik films. Three different solutions of 30% AA; DMA; and Ebycryl 645 (a bisphenol epoxy diacrylate available from Bostik, Inc., Wauwatosa, Wis.) in methanol were each used for grafting onto THV and FEP by the same procedure of Example 1. All three grafts appeared to be effective.

The THV 500-g-DMA was the only film that gave any bond to a Bostik embossing film. The laminates were press bonded at 145° C. for 10 minutes in a Wabash press. The untreated THV 500 control film does not stick when laminated under the same conditions. Peel strength for these laminates is reported in Table 3, below.

THV 500-g-DMA was also press bonded to a phenolic pre-preg (Cycom 6070, available from Cytec Engineered Materials, Anaheim, Calif.) at temperatures ranging from 135° C. to 182° C. in a Wabash press using 500 psi and a dwell time of 10 minutes. The THV 500-g-DMA could not be separated from the laminate at any spot. When untreated THV 500 control film was used, there were spots that adhered to the laminate and other spots where the THV easily separated from the laminate with no apparent bond strength.

### Example 5

Preparation of grafted white single layer THV film and laminated to Bostik 669 film. This film was wetted on the shiny side with methanolic solutions of 24% GMA, 15% freshly prepared acryloxysilane and 30% AA with 2% added TMPTA. The grafting was done according to the procedure of Example 1. The AA-graft was washed in water, the silane sample was dried under a stream of nitrogen and the GMA sample was washed in isopropanol. All of these samples were individually placed in Ziploc bags. These grafted materials were laminated to an epoxy-based film. The results compare very favorably to corona treated film. The untreated control film had no adhesion to the epoxy-based film.

TABLE 3
Peel strength of laminates of grafted THV film to Bostik films

| | Peel Strength | |
|---|---|---|
| Monomer | (N/cm) | Conditions |
| DMA | 2.4 | 145° C., 10 min, 500 psi |
| DMA^{a} | 2.8 | 145° C., 10 min, 500 psi |
| DMA^{a} | 4.3 | 145° C., 10 min, 500 psi |
| 30% AA^{b} | 7.3 +/− 0.1 | 160° C., 18 min, 500 psi |
| 15% acryloxysilane | 4.9 +/− 0.4 | 160° C., 18 min, 500 psi |

^{a}Bostik film product code 689 used, all other examples used Bostik film product code 669. Each are thermosetting resins, distinguished by, inter alia, flame retardant content.
^{b}2% added TMPTA

### Example 6

Preparation of grafted THV 500 film and lamination to STR-EVA film. The THV 500 film was grafted using a 20% concentration of a monomer mix in methanol by the method of Example 1. The monomer mix was comprised of about a 2:1 ratio of Sartomer CN 386 (amine acrylate acrylic ester (available from Sartomer Co.)) to AA with added 2.5% TMPTA. The 2:1 ratio provided a nearly neutral (pH) solution of coupled monomers. The film was wetted with grafting solution on both sides. Another piece of film was grafted in the same manner using a 20% methanolic solution of Sartomer SR 603 (PEG 600 diacrylate). Both grafted films were washed of any excess monomer with MEK and air dried. Both films appeared to be quite hydrophilic when re-wetted with water. These films were laminated to STR-EVA (vacuum laminated, 8 min, 145° C.) and tested for peel strength (values in Newtons) according to the method above. The untreated THV 500 control film does not bond to STR-EVA.

### Example 7

Preparation of grafted white solar cell film and THV film laminated to STR-EVA film. The THV-side of a white solar cell film (hereinafter THV-BB) laminate was grafted with several different grafting solutions and processed in the same manner as Example 1. The methanolic grafting solutions were 10% 3-acryloxypropyl trimethoxysilane, 10% vinyltrimethoxysilane (TMVS), 20% AA and 2% TMPTA; 20% sodium 2-acrylamido-2-methyl-1-propanesulfonate (AMPS); 20% 3-acrylamidopropyl-trimethylammonium chloride (APTAC); and 20% AA/CN 386 solution. The silane graft was dried under a stream of nitrogen and bagged under N₂. The grafts from the 20% AA solution and the mixed monomer system AA/CN 386 were hydrophilic. The others were not hydrophilic but could be clearly written on with a magic marker, indicating that some grafting had occurred.

### Example 8

Preparation of grafted white solar cell film with other grafting solutions and laminated to STR-EVA film. Methanolic solutions of 20% vinyl acetate; GMA; and isooctylacrylate (IOA) were each grafted to the solar film THV-side following the same method as Example 1. A 10% methanolic solution of SR 344 (PEG 400 diacrylate) (Sartomer Co.) was also grafted. The vinyl acetate graft was air-dried, the SR 344 graft was washed in water; and the GMA and IOA grafts were washed in isopropanol. Using a magic marker, clear marks were left on all of the grafted material. In the peel results reported below, the GMA graft has a high peel adhesion value. The lamination temperature may have been high enough for the epoxy group to ring-open and react with the substrate to form covalent bonds.

### Example 9

Preparation of grafted white solar cell film with grafting solutions and laminated to STR-EVA film. Methanolic solutions of 30% AA and 25% AA were prepared with 2% added TMPTA, also a 25% AA solution was prepared with no TMPTA. These solutions were used to graft the THV-side of the solar cell film using the same procedure as Example 1. Some of the material was grafted with the 20% solution of GMA for subsequent conversion to sulfonate groups. These were heated at 80° C. in a sulfonation solution and they developed a hydrophilic surface as a result. The sulfonation solution consisted of 10% sodium sulfite, 15% IPA and 75% water.

TABLE 4
Peel strength of laminates of grafted THV film to STR-EVA film.

| | Peel Strength | |
|---|---|---|
| Monomer | (N/cm) | Conditions |
| SR 603^{a} | 4.2 +/− 0.5 | 145° C., 8 min |
| AA/CN 386^{a} | 3.8 +/− 0.6 | 145° C., 8 min |
| MA^{a} | 5.9 +/− 0.1 | 145° C., 8 min |
| 20% AA^{b} | 26.7 +/− 1.6 | 125° C., 10 min |
| 10% acryloxysilane^{b} | 23.7 +/− 2.2 | 125° C., 10 min |
| 10% acryloxysilane | 18.5 +/− 1.4 | 125° C., 10 min |
| TMVS | 18.0 +/− 0.3 | 125° C., 10 min |
| SR 344 | 6.5 +/− 0.5 | 145° C., 8 min |
| IOA | 0.4 +/− 0.1 | 145° C., 8 min |
| VA | 11.9 +/− 1.2 | 145° C., 8 min |
| GMA | 33.7 +/− 1.4 | 145° C., 8 min |
| 25% AA | 9.1 +/− 0.9 | 145° C., 8 min^{c} |
| 25% AA^{b} | 29.4 +/− 0.5 | 145° C., 8 min |
| 30% AA^{b} | 30.1 +/− 0.5 | 145° C., 8 min |
| GMA-SO₃ | 24.8 +/− 1.9 | 145° C., 8 min |

^{a}Laminated to THV-500 film, other examples laminated to THV-BB
^{b}2% added TMPTA
^{c}Slip-stick behavior observed

What is claimed is:

1. A method of preparing a fluoropolymer laminate comprising:
providing a substantially solid partially fluorinated fluoropolymer film;
coating a first surface of the fluoropolymer film with a first solution comprising one or more polymerizable monomers to give a coated fluoropolymer film, wherein the one or more polymerizable monomers comprise at least one polymerizable monomer having (i) a free-radically polymerizable group and (ii) at least one additional functional group thereon, the additional functional group selected from an ethylenically unsaturated group, an epoxy group, an azlactone group, an isocyanate group, an ionic group, and a silane group;
forming a multilayer structure comprising the coated fluoropolymer film and a removable cover layer, wherein the first solution is disposed between the cover layer and the fluoropolymer film;
exposing the multilayer structure to a controlled amount of electron beam radiation so as to graft the one or more polymerizable monomers to the first surface of the fluoropolymer film to provide a functionalized fluoropolymer film;
removing the cover layer from the multilayer structure; and
laminating to the first surface of the functionalized fluoropolymer film a second polymer layer wherein the second polymer layer comprises at least one complementary functional group that associates with the functionalized fluoropolymer film.

2. The method of claim 1, further comprising:
after exposure to an electron beam, leaving the cover layer on the multilayer structure for a period of time of at least 15 seconds prior to the removing step.

3. The method of claim 1, wherein the cover layer comprises polyethylene terephthalate film material.

4. The method of claim 1, wherein the complementary functional group is a nucleophilic group.

5. The method of claim 4, wherein the nucleophilic group is selected from a primary amino, secondary amino, carboxy, and hydroxy.

6. The method of claim 1 further comprising coating the functionalized fluoropolymer film with one or more reactants and reacting the functionalized fluoropolymer film with the one or more reactants.

7. The method of claim 1, wherein the additional functional group is an ionic group.

8. The method of claim 1, wherein the additional functional group is an ethylenically unsaturated group.

9. The method of claim 1, wherein the additional functional group comprises an ethylenically unsaturated group, a monomer having the additional functional group comprising an epoxy group, or a combination thereof.

10. The method of claim 9, wherein the additional functional group is an epoxy group and wherein the complementary functional group is a nucleophilic group.

11. The method of claim 1, wherein the fluoropolymer film comprises repeating units derived from tetrafluoroethylene and at least one ethylenically unsaturated monomer.

12. The method of claim 11, wherein the ethylenically unsaturated monomer is selected from ethylene and propylene.

13. The method of claim 11, wherein the ethylenically unsaturated monomer is selected from vinylidene fluoride, hexafluoropropylene, and combinations thereof.

14. The method of claim 1, wherein the additional functional group is an epoxy group, further comprising, before the laminating step but after the removing step, sulfonating the epoxy group to yield a sulfonate group.

15. The method of claim 1, further comprising:
rinsing the functionalized fluoropolymer film to remove any unreacted monomer;
coating the first surface of the functionalized fluoropolymer film with a second solution comprising one or more polymerizable monomers, wherein the one or more polymerizable monomers comprise at least one polymerizable monomer having (i) a free-radically polymerizable group and (ii) an ethylenically unsaturated group, epoxy group, azlactone group, isocyanate group, or ionic group thereon; and
exposing the substrate to a controlled amount of electron beam radiation so as to graft the one or more polymerizable monomers of the second solution to the fluoropolymer film.

16. The method of claim 1 wherein the complementary functional group reacts with the functionalized fluoropolymer film to form a covalent bond between the fluoropolymer film and the second polymer layer.

17. The method of claim 1 further comprising:
coating a second surface of the fluoropolymer film with a second solution comprising one or more polymerizable monomers, wherein the one or more polymerizable monomers comprise at least one polymerizable monomer having (i) a free-radically polymerizable group and (ii) at least one additional functional group thereon, the additional functional group selected from an ethylenically unsaturated group, an epoxy group, an azlactone group, an isocyanate group, an ionic group, and a silane group;
forming a multilayer structure comprising the coated fluoropolymer film and a removable carrier layer, wherein the second solution is disposed between the carrier layer and the fluoropolymer film;
exposing the multilayer structure to a controlled amount of electron beam radiation so as to graft the one or more polymerizable monomers to the second surface of the fluoropolymer film to provide a functionalized fluoropolymer film;
removing the carrier layer from the multilayer structure; and
laminating to the second surface of the functionalized fluoropolymer film a third polymer layer wherein the third polymer layer comprises at least one complementary functional group that associates with the functionalized fluoropolymer film.

18. A method of preparing a functionalized fluoropolymer film comprising:
providing a substantially solid partially fluorinated fluoropolymer film;
coating a first surface of the fluoropolymer film with a first solution comprising one or more polymerizable monomers to give a coated fluoropolymer film, wherein the one or more polymerizable monomers comprises at least one polymerizable monomer having (i) a free-radically polymerizable group and (ii) an ethylenically unsaturated group, an epoxy group, an azlactone group, an isocyanate group, an ionic group, or a silane group thereon; and
exposing the coated fluoropolymer film to a controlled amount of electron beam radiation so as to graft the one or more polymerizable monomers to the fluoropolymer film.

19. The method of claim 18, further comprising contacting the coated fluoropolymer film with a cover layer.

20. The method of claim 18, wherein the controlled amount of electron beam radiation exposure comprises a dosage ranging from about 2 Mrad to about 4 Mrad.
